(19) United States
(12) Patent Application Publication
(10) Pub. No.: US 2006/0169055 A1
(43) Pub. Date: Aug. 3, 2006

(54) Method and system for measuring fluid level in a container

(75) Inventors: Uri Agam, Montreal (CA); Eli Gal, Montreal (CA)

Correspondence Address: AGENCE DE BREVETS FOURNIER, 240 GUILLAUME-BARRETTE, LA PRAIRIE, QC, JR5-6L7, CA

(73) Assignee: Sensotech

(21) Appl. No.: 11/029,415

(22) Filed: Jan. 6, 2005

(51) Int. Cl. G01F 1/32

(52) U.S. Cl. 73/861.23

(57) ABSTRACT

The method and system for measuring a fluid level in a container according to the present invention allow measuring fluid level in confined volumes where, for example, there is no sufficient space to locate the ultrasonic transducer, where the fluid level constantly changes, such as in a vehicle gas tank, where the properties of the fluid or geometry of the tank changes with the environmental conditions, or where a high precision is required. The method composes i) emitting an ultrasound beam from a source along an ultrasound beam path generally oriented towards the bottom of the container, ii) receiving ultrasound echo values indicative of changes of environment along the ultrasound beam path; and iii) using the echo values to determine distance from the source of the changes of environment along the ultrasound beam path; whereby, a fluid level in the container is determined by associating at least one of said echo values to a fluid interface. A waveguide in the form of a pipe may be used in defining the ultrasound beam path and reduced clutter. A fixed target along the ultrasound beam path allows continuous calibration of the system to cope for environment changes in the container and for changes of properties of the fluid. A measurement window can further be used to minimize false reading and to cope with environment changes.

### FIELD OF THE INVENTION

The present invention relates to fluid level measurement in a container. More specifically, the present invention relates to method and system for fluid level measurement in an encapsulated container such as a car gas tank or the like using ultrasound.

### BACKGROUND OF THE INVENTION

Many techniques are known to measure liquid level in a container. For example, Williamson et al, in U.S. Pat. No. 4,189,793 issued on Feb. 26, 1980 and entitled “Automatic liquid Dispenser for an Inverted Bottle” disposes the use of a buoy mechanical system. The use of a buoy with a mechanical lever connected to a rheostat or a conductor or another method of detecting the buoy level are also well known and can be find in numerous products.

Using ultrasound for measuring levels of liquid is also well known. In the U.S. Pat. No. 4,890,490, issued on Jan. 2^{nd} 1990, and entitled “Liquid Level Monitoring”, Telford discloses such a system to measure liquid levels in extreme environment, such as in a nuclear reactor. Telford's proposed system is based on ultrasonic Lamb waves travelling along a waveguide including discontinuities, where variations in the waveforms travelling along the waveguide are indicative of the liquid level.

However, Telford's system does not allow coping with variations in the environment of the fluid, including changes in the states of the fluid and he container geometry. Moreover, Telford's system is inadequate for measuring liquid in odd shape containers and when in moving containers.

### OBJECTS OF THE INVENTION

An object of the present invention is therefore to provide improved method and system for measuring fluid level in container.

### SUMMARY OF THE INVENTION

A method and system for measuring fluid level in a container according to the present invention allows measuring fluid level in confined volumes where, for example, there is no sufficient space i) to locate the ultrasonic transducer, ii) to route the ultrasonic beam, or to prevent dead zone, where the fluid level constantly changes, such as in a vehicle gas tank, where the properties of the fluid or the geometry of the tank changes with the environmental conditions, or where high precision is required.

More specifically, in accordance with a first aspect of the present invention, there is provided a system for measuring fluid level in a container comprising; an ultrasound sensor for emitting an ultrasound beam along an ultrasound beam path generally oriented towards a fluid interface in the container and for receiving ultrasound echoes indicative of changes of environment in the container along said ultrasound beam path; and a controller coupled to said ultrasound sensor for using said echoes for determining respective distances from said sensor of said changes of environment along said ultrasound beam path and for determining a fluid level in the container by associating at least one of said echo values to the fluid interface.

More specifically, embodiments of system for measuring fluid levels in a container according to the present invention are provided where either one or both of i) a variable threshold where the threshold is established in reference to the residual decaying excitation pulse and ii) an acoustic waveguide for defining an ultrasound beam path is used allow to minimize the dead zone.

The waveguide can be in the form of a bent/curved or linear pipe that can be provided with a general configuration allowing guiding the ultrasound beam around obstacles. This allows the use of a single sensor where a plurality of sensors would normally be required. Moreover, the use of a waveguide allows reducing the clutter and the noise, and thus simplifies the electronic requirement for analysing the measurements. It allows for self calibration to eliminate automatically and continuously environment and liquid mixture effects.

In accordance with a second aspect of the present invention, there is provided a method for measuring fluid level in a container, the method comprising: i) emitting an ultrasound beam from a source along an ultrasound beam path intersecting a fluid interface in the container; ii) receiving ultrasound echo values indicative of changes of environment along said ultrasound beam path; and iii) determining a fluid level in said container by associating at least one of said echo values to the fluid interface.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1 is a sectional view of a gas tank assembly including a gas level gauge according to a first illustrative embodiment of a system for measuring fluid level in a container from the present invention;

FIG. 2 is a block diagram illustrating an ultrasound sensor part of the gas level gauge from FIG. 1;

FIG. 3A is a sectional view of a gas tank assembly including a gas level gauge according to a more specific embodiment of the system from FIG. 1, illustrating the gas tank tilted;

FIG. 3B is a close-up view of the pipe form the gas level gauge from FIG. 1, taken from line 3B-3B from FIG. 3A;

FIG. 4 is a sectional view of a gas tank assembly including a gas level gauge according to a second illustrative embodiment of a system for measuring fluid-level in a container from the present invention;

FIG. 5 a sectional view of a gas tank assembly including a gas level gauge according to a third illustrative embodiment of a system for measuring fluid level in a container from the present invention;

FIG. 6A is sectional view of a gas tank assembly including a gas level gauge according to a fourth illustrative embodiment of a system for measuring fluid level in a container from the present invention;

FIG. 6B is a sectional view of the gas tank assembly from FIG. 6A, illustrating both the gas tank and the pipe from the gas level gauge in an expanded configuration;

FIG. 7 is a partial sectional view of a gas tank assembly including a gas level gauge according to a fifth illustrative embodiment of a system for measuring fluid level in a container from the present invention;

FIG. 8 is a sectional view of a gas tank assembly including a gas level gauge according to a sixth illustrative embodiment of a system for measuring fluid level in a container form the present invention;

FIG. 9A-9B are partial sectional views of a gas tank assembly including a gas level gauge according to an seventh illustrative embodiment of a system for measuring quid level in a container from the present invention; and

FIG. 10 is a flowchart illustrating a fluid level measuring method according to an illustrative embodiment of a second aspect of the present invention.

### DETAILED DESCRIPTION

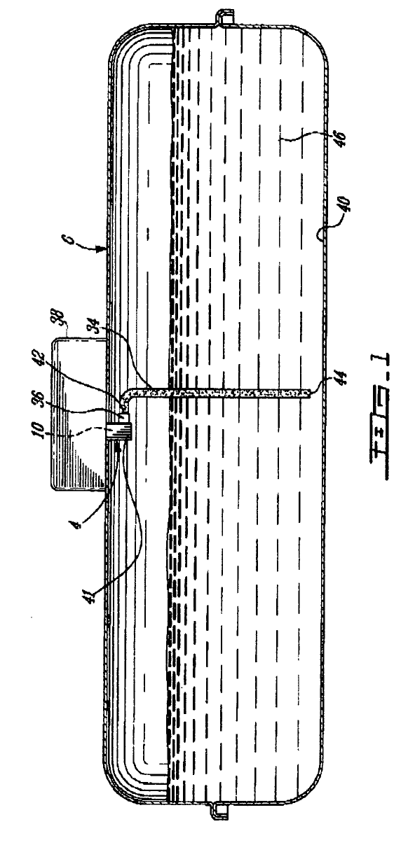

A system 4 for measuring a fluid level in a container 6 will now be described with reference to FIG. 1. The system 4 is in the form of a gas level gauge mounted to a container 6 in the form of a vehicle gas tank assembly.

The gas level gauge 4 includes an ultrasound sensor system 10 and a conduit 34 defining an ultrasound beam path for both the ultrasonic pulse 30 generated by the ultrasound system 10 and the returning pulse or echo 32. The conduit 34 is mounted to the ultrasound sensor system 10 via a mechanical coupler 36 allowing forcing the generated ultrasonic pulse 30 along the ultrasound beam path.

The gas level gauge 4 is mounted to the tank 6 via a mounting assembly 38 so that the ultrasonic pulse 30 is emitted in the tank 6, towards the bottom thereof 40. As it is well known in the art, the mounting assembly 38 may also be configured to mount other mechanical or electrical equipments to the tank 6.

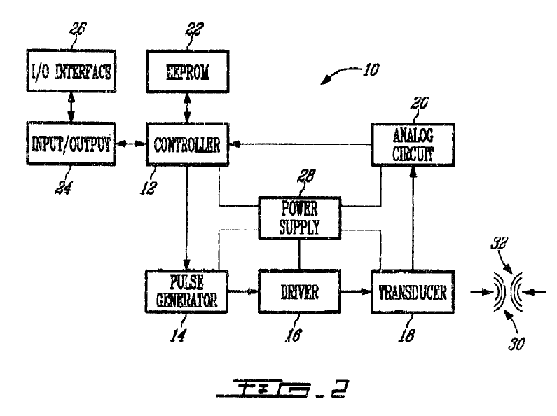

The ultrasound sensor system 10 will now be described with reference to FIG. 2.

The sensor system 10 comprises a controller 12, a pulse generator 14 coupled to the controller 12, a sensor driver 16 coupled to the pulse generator 14, a transducer 18 coupled to the driver 16, an analog circuit 20 coupled to both the transducer 18 and to the controller 12, a memory means in the from of an EEPROM (Electrically Erasable Programmable Read Only Memory) 22 coupled to the controller 12, input/output (I/O) means 24, and an I/O interface coupled to the I/O means 24. The controller 12, pulse generator 14, sensor driver 16, transducer 18, and analog circuit 20 are connected to a power supply 28, in the form, for example, of a 12-24 DC (Direct Current) voltage source. Of course, the power supply 28 may take other forms allowing energizing the system 10, such as, a vehicle power supply.

The pulse generator 14 includes an oscillating circuit and allows generating a pulsed signal having a frequency, preferably above the range of human hearing. This pulsed signal is amplified to the appropriate voltage and driven to the transducer 18 by the sensor driver 16. The transducer 18 converts the voltage from the driver 16 to an ultrasonic pulse 30 that propagates through the tank 6 generally along the ultrasound beam path, and reflects back in the form echoes 32 to the transducer 18 indicative of the environment changes along the ultrasound beam path, such as fluid interfaces.

The transducer 18 converts the reflected pressure wave (or echo) 32 into an echo voltage, which is amplified and filtered by the analog circuit 20. The echo voltage is then digitized and analysed by the controller 12 to assess the presence of a change of environment along the ultrasound beam path as will be explained hereinbelow in more detail. The controller 12 is configured to drive the transducer 18 via the pulse generator 14 and driver 16 to emit ultrasound wave pulses at a selected frequency and to collect echoes at different period of time.

The controller 12 is further configured to generate an output signal indicative of changes of environment along the ultrasound beam path and to output this signal to the I/O Interface 26 via the I/O means 24. According to the embodiment illustrated in FIG. 1, the gas level gauge transmits the computer level of gasoline 46 to the car central controller (not shown).

The controller 12 may take many forms, from an electronic circuit to a dedicated microchip or a programmed computer. According to the illustrative embodiment of FIG. 1, referring to a gas tank of a vehicle such as a car, the controller functions may be embodied in the car central controller (not shown). Other components of the sensor system 10, such as the I/O interface 26, EEPROM 24 and input/output means 24 can also be can also be part of the car's computer/electronic controller.

Of course, the memory 22 may also take other forms, such as a computer hard drive, a memory card used in connection with a memory card reader, a Read-Only Memory, etc. The memory 22 allows storing fluid level information as processed by the controller 12 and any information required by the controller 12 in assessing the fluid level, such as geometry of the container 6 as will be explained in more detail hereinbelow.

The detection system 10 is enclosed in a casing 41, including an opening for the ultrasonic pulse, for protecting the sensor system 10 and for allowing its mounting directly on the tank 6 or on the mounting assembly 38 as illustrated in FIG. 1. As discussed hereinabove, the mechanical coupling 36 between the casing and conduit 34 allows forcing the ultrasonic pulse 30 trough the conduit 34.

Since, pulse generators, sensor drivers, transducers, EEPROM, I/O means and interfaces are believed to be well known in the art, they will not be described herein in more detail.

The detection system 10 may have other configuration allowing i) generating and emitting an ultrasound beam from a source along an ultrasound beam path; ii) receiving ultrasound echo values indicative of changes of environment along the ultrasound beam path; and iii) using the echo values to determine distance from the source of changes of environment along the ultrasound beam path.

It is to be noted that although the sensor system 10 is illustrated in FIG. 1 as being located within the gas tank 6, it can also be so secured to the mounting assembly 38 or directly to the tank 6 as to be located outside the tank 6.

The conduit 34 is in the form of a tube or pipe having a first aperture at its proximate end 42 for allowing ultrasonic waves 30 to radiate from the sensor system 10 and echoes 32, and a second aperture at its distal end 44 allowing the fluid 46 to freely flow therein and receiving reflected ultrasound waves 32. The pipe 34 defines a waveguide defining an ultrasound beam path. The pipe 34 can be provided with additional apertures along its length. The measurements may take place inside or outside the waveguide depending if the pipe 34 extends to the bottom 40 of the tank 8.

The pipe 34 is made of a material providing sufficient rigidity to maintain a predetermined configuration. Examples of such materials include polymers, rubber, composite metal, etc. Of course, since the pipe 34 acts as a waveguide, its inner surface should allow propagation of the ultrasonic waves 30 and echoes 32 therein. In embodiments where a less rigid material is used for the pipe 34, the pipe 34 may be attached to the tank 6, for example by attaching its distal end 44 to the bottom 40 of the tank 6. The pipe 34 is made of a material which does not react with the fluid 46.

The use of a pipe 34 in defining an ultrasound beam path allows reducing clutter and noise that would normally occurs following multiple reflections of the ultrasound waves on the inner surface of the tank 6, should a pipe 34 not be present.

Even though, the pipe 34 is illustrated in FIG. 1 not extending along the entire depth of the tank 6, a longer pipe can also be use.

Before operation, the gas level gauge 4 is first calibrated to cope for the geometry of the tank assembly 6, the nature and properties of the fluid to detect and properties of the gauge 4, including more specifically those of the pipe 34, such as its shape and material.

In operation, the sensor system 10 periodically emits ultrasound waves 30 and analyses the returning echoes 32 so as to determine the liquid level in the tank 6. The detecting period may vary depending on the required precision. Alternatively, the sensor system 10 may be triggered by the car's computer.

In some applications, level measurements are taken at time interval shorter than anticipated noticeable changes. This may allow minimizing or preventing the occurrences of false readings caused, for example, by rain when the container is opened, level movements and splash, indeed, taking measures at sufficiently short intervals of time allows disregarding false measurements without compromising the reliability of the results.

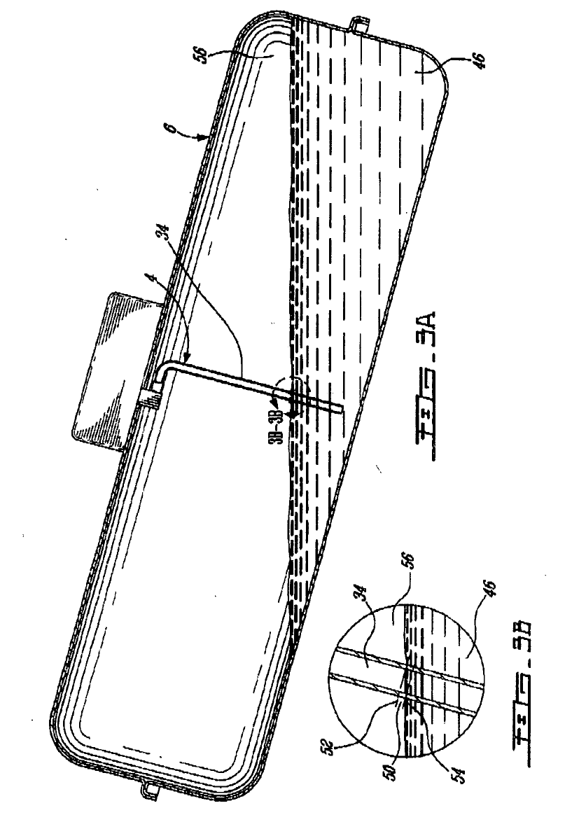

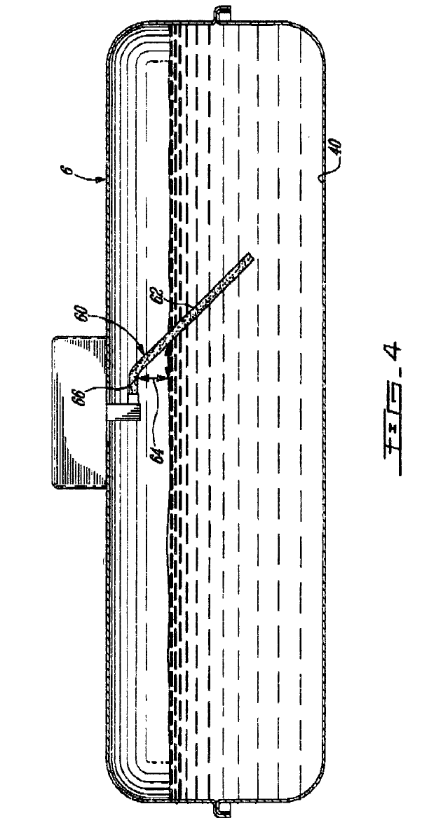

FIGS. 3A and 3B illustrate a more specific embodiment of the gas level gauge 4 allowing determining the gas level in the tank 6 even when the tank 6 is tilted.

As can be better seen from FIG. 3B, the tilting of the tank 6 results in a transition window 50 in the pipe 34 delimited by first and second cross-section 52-54 along the length of the pipe 34. The first cross section 52 corresponds to the end of the first encountered fluid 56, which is a mixture of air and volatile components evaporated from the gasoline 46. The second cross-section 54 corresponds to a level in the pipe 34 including only gasoline 46. The transition window 60 corresponds to the cylindrical shape volume between the two cross-sections 52-54. The controller 12 may be configured to recognize the signature of such a transition window 50 from the reflected echoes from this region and determine its height, which can then be used to determine the tilt or the tank 6. Knowing both the tilt and the geometry of the tank 8, the controller 12 may then determine the level and volume of fluid in the tank 6.

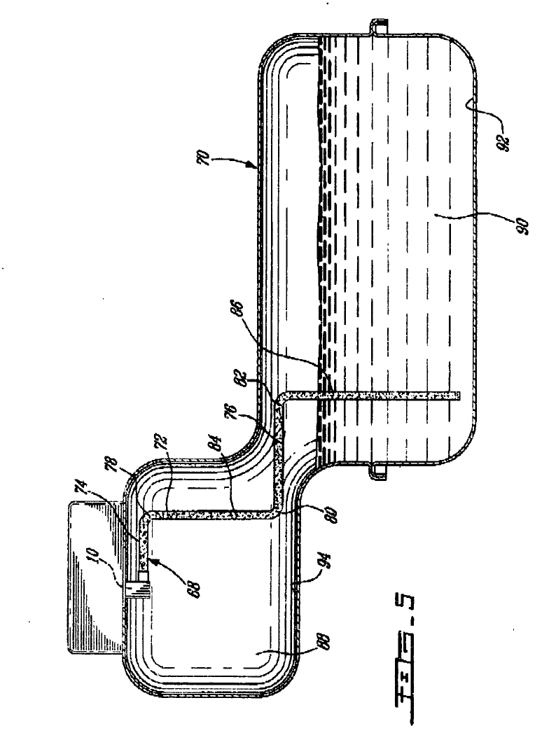

Turning now to FIG. 4, a system 60 for measuring a fluid level in a container 6 according to a second illustrative embodiment of the present invention will be described in more detail. Since the system 60 is very similar to the system 4 from FIG. 1 and for concision purposes, only the differences between the two embodiments will be described herein in more detail. The system 60 is in the form of a gas level gauge.

According to this second illustrative embodiment, the pipe 62 is similar to the pipe 34, with a difference that it is not positioned relatively to the bottom 40 of the tank 6 so as to define an ultrasound beam path which is perpendicular thereto. Indeed, in some applications, the configuration of the tank may not allow the pipe 62 to be positioned so as illustrated in FIG. 1.

The controller 12 of the gas level gauge 60 is configured so as to take into account the known angle of the pipe 62 relatively to the bottom 40 of the tank 6 in using the received echo values to determine distance from the source of changes of environment along the ultrasound beam path and therefore the liquid level. More specifically, only the perpendicular component of the ultrasound beam path (see arrow 64) relatively to the bottom 40 of the tank 6 is considered in calculating the level. Of course, calibrating the gas level gauge 60 before operation allows taking into account any additional portion of the pipe which is not perpendicular to the bottom 40 of the tank 6 and therefore to the surface of the liquid, such as portion 66 in the illustrated embodiment.

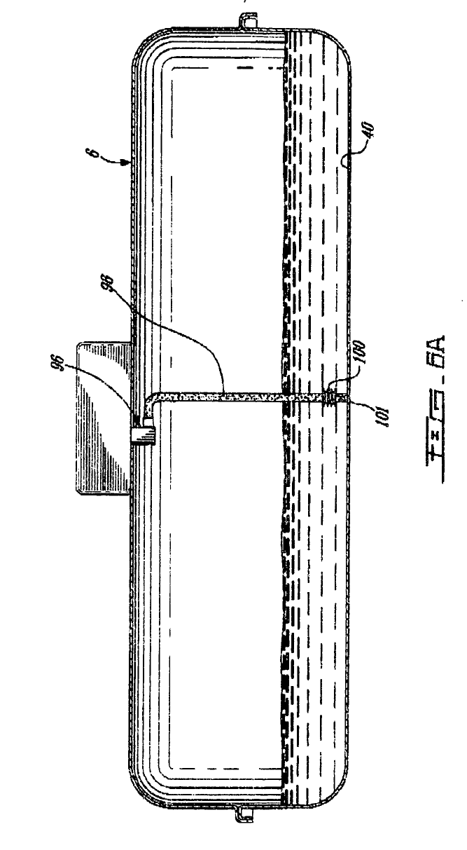

A gas tank assembly 6 including a gas level gauge 68 according to a third illustrative embodiment of a system for measuring fluid level in a container from the present invention will now be described with reference to FIG. 5. Since the system 68 is very similar to the system 4 from FIG. 1, only the differences between the two embodiments will be described herein in more detail.

The gas level gauge 68 further allows measuring levels of gasoline in an odd shape tank 70. For that purpose, the level gauge 68 comprises a pipe 72 including two horizontal sections 7476 and three elbow portions 78-82, in addition to two vertical sections 84-86, defining a non linear ultrasound beam path allowing the ultrasound waves 30 produced by the sensing device 10 to reach throughout the two offset portions 88 and 90 of the tank 6. As it has been described with reference to the previous illustrative embodiment, the gas level gauge 68 is configured so as to take into account only the perpendicular component of the beam path relatively to the bottom sections 92-94 of the tank 70 in calculating the level. In addition, the controller 12 is configured to access and use a look-up table, stored for example into the memory device 22, for associating a position along the beam path to a volume.

It is believed to be within the reach of a person skilled in the art to adapt the level gauge 68 for other containers having odd shapes or varying cross sections across their height.

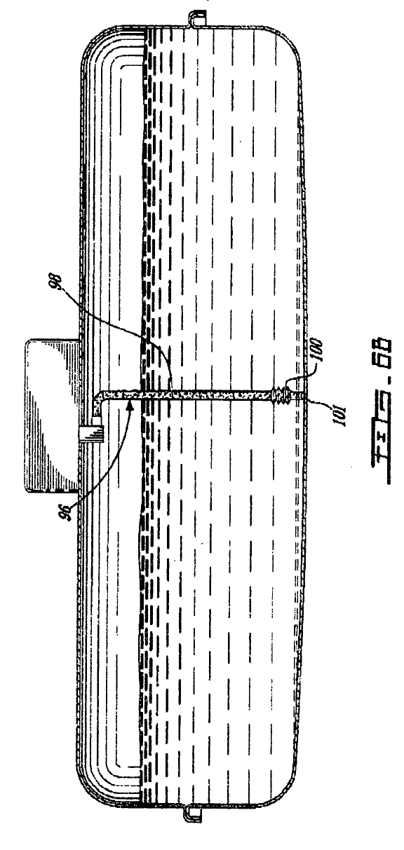

A gas tank assembly 6 including a gas level gauge 96 according to a fourth illustrative embodiment of a system for measuring fluid level in a container from the present invention will now be described with reference to FIGS. 6A-6B. Since the system 96 is very similar to the system 4 from FIG. 1, only the differences between the two embodiments will be described herein in more detail.

The gas level gauge 96 is provided with a waveguide in the form of a longitudinally extendable pipe 98 secured to the bottom 40 of the tank 6. The pipe 98 includes a strain relief in the form of an accordion portion 100, allowing the extension of the pipe 98 when the volume of the tank 6 changes, due to changes in pressure and liquid weight for example. These changes in the configuration of the tank 6 change the position of the reference point of the tank 6. However, using a fixed target 101 on the tank floor as a reference point, comparing the measured level with this reference point and providing an extendable pipe 98 allows providing accurate liquid level readings even when the tank 6 is deformed.

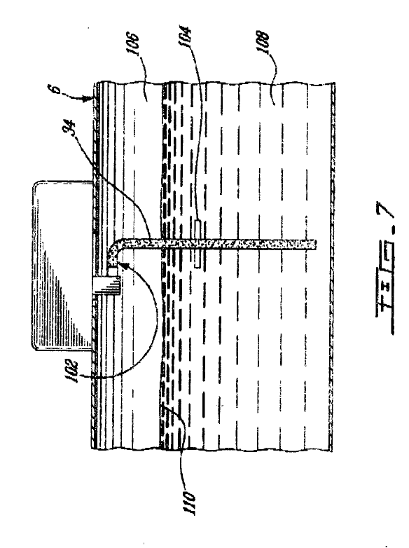

A gas tank assembly 6 including a gas level gauge 102 according to a fifth illustrative embodiment of a system for measuring fluid level in a container from the present invention will now be described with reference to FIG. 7. Since the system 102 is very similar to the system 4 from FIG. 1, only the differences between the two embodiments will be described herein in more detail.

The gas level gauge 102 includes a fixed target, in the form of a pin 104 transversally inserted in the pipe 34 so as to be positioned in the beam path defined by the pipe 34.

The use of a fixed target 104 along the ultrasound beam path allows for self calibration of the system 102 to cope for the variations of the speed of sound in the mediums 106-108 where the ultrasound waves travel, the measurements being based on the time of travel of the sound in the medium 106-108. Since the speed of travel of the ultrasound waves depends on the properties of the mediums and that such properties vary with its temperature, pressure and density, periodic calibration of the system through the use of a fixed target 104 allows providing for reliable measurements even when the measurement conditions vary.

In operation, measurements of the position of a fluids interface 110 are compared to the known position of the pin 104 along the beam path and therefore its known distance from the source 18 to determine the actual fluid levels.

The fixed target 104 can take other forms than a pin inserted in the pipe 34. Indeed, any object positioned along the beam path, inside or outside the pipe, that does not obstruct the beam path can be used.

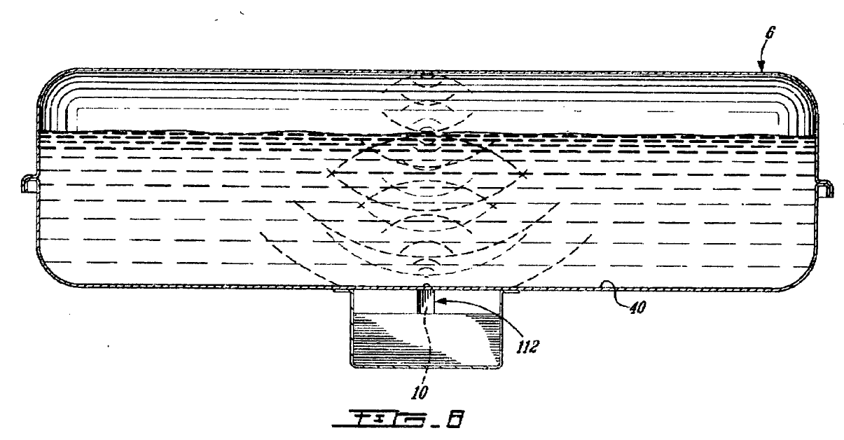

FIG. 8 illustrates a system 112 for measuring liquid level in a tank 6 according to a sixth illustrative embodiment of the present invention. Again, since the system 112 is similar to the system 4 illustrated in FIG. 1, and for concision purposes, only the difference will be described herein in more detail.

The system 112 does not include a waveguide and the ultrasound sensing system 10 is positioned at the bottom 40 of the tank 40. Indeed, since a system for measuring fluid level in a container according to the present invention determines the fluid level by measuring the position of interfaces between different fluids in the container, the interface can be detected from the bottom or from the top of the container 6. Of course, the ultrasound sensing system 10 is sealed so as to prevent leakage from the bottom of the liquid tank 6.

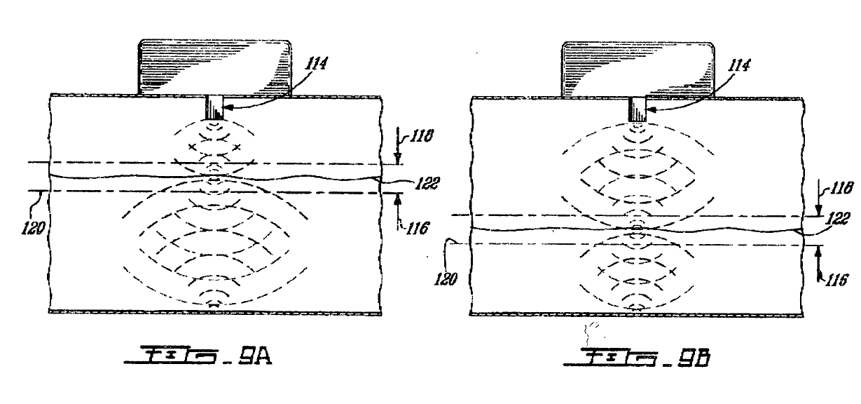

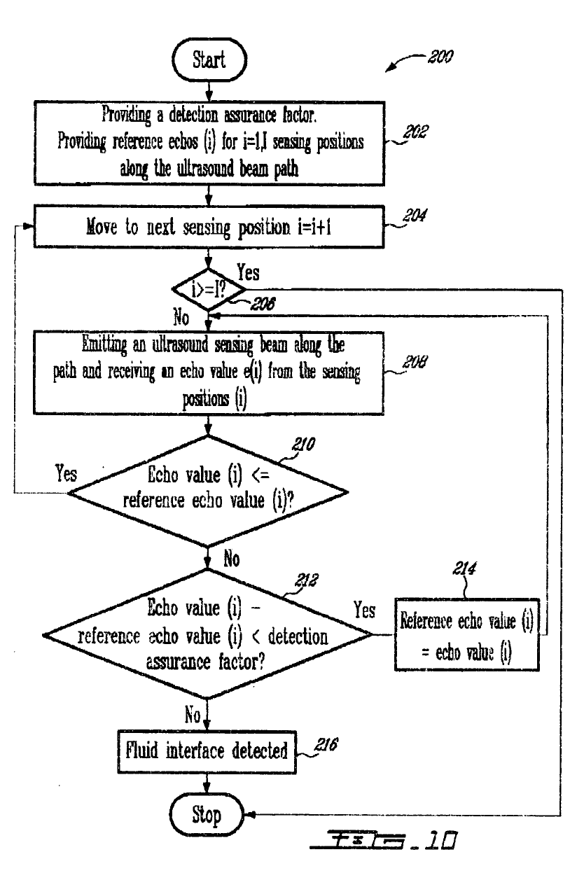

A gas tank assembly 6 including a gas level gauge 114 according to a seventh illustrative embodiment of a system for measuring fluid level in a container from the present invention will now be described with reference to FIGS. 9A-9E. Since the system 114 is very similar to the system 4 from FIG. 1, only the differences between the two embodiments will be described herein in more detail.

Firstly, the fluid level gauge 114 does not include a pipe and the ultrasound beam path is determined by the direction of propagation of the ultrasound waves 30 which is determined by the orientation of sensing device 10 and more specifically of the transducer 18.

The controller 12 is further configured so as to define a virtual measurement window 116 along the ultrasound beam path. The window 116 is characterized by upper and lower limit positions 118-120 along the beam path. The upper and lower limit positions 118-120 can be positioned at the same distance from the prior level measurement 122 or the upper and lower limit positions 118-120 can be set at different distances from the last measured level 122.

In operation, the upper and lower limit positions 118-120 are initially set in relation to a first measured liquid level or to a known liquid level 122. The distances of the upper and lower limit positions 118-120 from this liquid level are set so as to define a window 116 on the ultrasound beam path wherein the analysis of the received echoes will be limited. Therefore, the width of the window 116 and its position around the actual liquid level are determined considering the expected rate of change of the liquid level. For example, a wider window 116 will be used to cope for faster expected rates of change of the liquid level, while a narrower window 116 win be used when the expected rates of change of the liquid level are relatively slow. Alternatively, an adaptative window can also be used, where its width is determined dynamically according to the measured rate of change of the liquid level 122. In any case, the position of the upper and lower limit positions 118-120 relatively to liquid level 122 can be determined during an initialisation step during, for example, a calibration of the system 114.

The use of the measurement window 116 allows limiting false measurement due to clutter, splash and general movement of the liquid in the liquid 6. Moreover, the use of the measurement window 116 allows speeding the liquid level determination by limiting the quantity of measurement to consider. Also, the use of a measurement window allows coping for example for both fast and slow movements of the liquid level.

Even though the use of a measurement window has been described with reference to an illustrative embodiment 114 where no waveguide is used, a measurement window can also be considered with a system for measuring fluid level in a container including a waveguide, such as systems 4, 60, 68, 96 and 102. Moreover, the a measurement window can be used in addition to a fixed target, as described in relation with the illustrative embodiments 96 and 102.

Finally, a method 200 for measuring the fluid level in a container according to an illustrative embodiment of the present invention will now be described with reference to FIG. 10. The method 200 comprises determining a variable threshold that allows establishing a detection threshold for the fluid interface considering the residual decaying excitation pulse. As will become more apparent upon reading the following description of the method 200, the method 200 contributes to minimizing the dead zone.

In step 202, reference echoes (i) for each of the number 1 of sensing positions (i) along the beam path are provided. A detection assurance factor is also provided. The detection threshold dt(i) at the sensing position (i) equals the sum of the reference echo (i) at that position and the assurance factor.

The assurance factor serves to minimize false detections caused by an echo signal from the background, i.e. not being caused by an actual fluid interface to be detected, being greater than the threshold. The assurance factor is selected so as to yield a margin over the measured voltage sufficient to minimize the tripping of the detection system 10 by noised signal.

In some applications. It Is appropriate to provide more than one assurance factor, such as a predetermined assurance factor for each sensing position.

Step 204 allows iterating on all the sensing position. In step 206, it is verified whether all the scanning positions have been processed. If all the thresholds have been re-evaluated for each sensing position, the method stops until a new re-evaluation of the thresholds.

The frequency and timing of the detection threshold evaluation may vary. For example, a cycle may be established wherein the evaluation of the detection thresholds for all sensing positions alternates with the actual detection. Alternatively, the evaluation of the threshold for each position may be performed concurrently with the detection at each sensing position, as will be described hereinbelow. Of course, other detection threshold evaluation timing may be established.

In step 208, an ultrasound sensing beam is emitted along the beam path and an echo e(i) corresponding to the sensing position (i) is received. The echo (i) is received in the form of a voltage value.

The echo (i) received for the distance corresponding to the current sensing position (i) is compared by the controller 12 to the reference echo (i) corresponding to the same distance from the sensing system 10 along the beam path (step 210), which is stored as voltage amplitude in the EEPROM 22.

If the measured echo value (i) is lower or equal than the reference echo value (i) then the method proceeds with the next sensing position (i+1) and returns to stop 204. The target detection threshold for the sensing position (i) is equal to the sum of the reference echo value (i) and the assurance factor.

If the measured echo value (i) is greater than the reference echo value (i), then verification is performed as to whether the difference between the echo value (i) and the reference echo value (i) exceeds the detection assurance factor. If this is the case, then it mans that an actual fluid interface has been detected (step 216) and the method stops. The fluid level determination then proceeds with the controller 12 sending an output signal via the I/O means 24 indicative of the fluid level. If not, than an iterative process begins where a) the echo value (i) is stored on the memory 22 as the new reference echo value (i) for the current sensing position (step 122), and b) steps 116-120 are repeated until the measured echo value (i) is lower or equal to the reference echo value (i).

Even though a system for measuring fluid level according to the present invention has been described with reference to illustrating embodiments including a single transducer for both emitting and receiving ultrasound beam and echoes, two transducers can also be used, one for emitting the ultrasound beam and the other one for receiving returning echoes. This may allow the use of transducers requiring a dead zone, to operate correctly.

The method 200 can be implemented in any of the system for measuring fluid level in a container from the present invention as described hereinabove.

A level gauge according to the present invention and more specifically its controller may be configured to determine the position or height of interfaces between one of more fluids in the container. In such cases, a calibration process is performed, where for example measures are taken in the tank including a known amount of each of a plurality of un-mixable fluids of different density.

Even though the present invention has been illustrated with reference to a gas level gauge, it is believed to be within the roach of a person of ordinary skills in the art to adapt the present teaching for any other application where a fluid level is to be determined.

Although the present invention has been described hereinabove by way of preferred embodiments thereof, it can be modified, without departing from the spirit and nature of the subject invention as defined in the appended claims.

What is claimed is:

1. A system for measuring fluid level in a container comprising:
an ultrasound sensor for emitting an ultrasound beam along an ultrasound beam path generally oriented towards a fluid interface in the container and for receiving ultrasound echoes indicative of changes of environment in the container along said ultrasound beam path; and
a controller coupled to said ultrasound sensor for using said echoes for determining respective distances from said sensor of said changes of environment along said ultrasound beam path and for determining a fluid level in the container by associating at least one of said echo values to the fluid interface.

2. A system as recited in claim 1, further comprising a fixed target secured to the tank or to said ultrasound sensor so as to partially intersect said ultrasound beam path; said controller being configured to compare said at least one of said echo values associated to the fluid interface to a predetermined position of said fixed target along said ultrasound beam path to determine said fluid level.

3. A system as recited in claim 1, further comprising a conduit coupled to said ultrasound sensor and being mounted to the container at least partially therein for forcing the ultrasound beam along said ultrasound beam path.

4. A system as recited in claim 3, wherein further comprising a fixed target secured to the conduit so as to intersect said ultrasound beam path; said controller being configured to compare said at least one of said echo values associated to the fluid interface to a predetermined position of said fixed target along said ultrasound beam path to determine said fluid level.

5. A system as recited in claim 4, wherein said foxed target is in the form of a pin inserted through said conduit.

6. A system as recited in claim 3, wherein said conduit is in the form of a tube having a proximate end mounted to said ultrasound sensor, for allowing said ultrasonic beam therein and for guiding said ultrasonic beam along sold ultrasound beam path, and a having a distal end for allowing fluid therein and for receiving said echoes.

7. A system as recited in claim 6, wherein said tube is provided with at least one aperture along its length for allowing fluid therein.

8. A system as recited in claim 6, wherein said tube is made of a material selected from the group consisting of polymer, rubber, composite material and metal.

9. A system as recited in claim 3, wherein said conduit extends substantially along the depth of the container.

10. A system as recited in claim 3, wherein said conduit is mounted to the container via a mechanical coupler.

11. A system as recited in claim 10, wherein said ultrasound sensor is enclosed in a casing including an opening for the ultrasound beam; said mechanical coupler being mounted to said casing so as to force said ultrasound beam through said conduit.

12. A system as recited in claim 3, wherein said conduit is non linear.

13. A system as recited in claim 3, wherein said conduit includes at least one section defining an angle with said fluid interface.

14. A system as recited in claim 1, wherein said ultrasound sensor is mounted to the container via a mounting assembly.

15. A system as recited in claim 1, wherein said ultrasound sensor including:
an ultrasound pulse generator for generating an ultrasound pulse signal; and
at least one transducer coupled to the ultrasound pulse signal generator for receiving said ultrasound pulse signal, for emitting the ultrasound beam in the container in response to said ultrasound pulse signal, and for receiving the ultrasound echoes indicative of the changes of environment in the container in response to said ultrasound beam.

16. A system as recited in claim 15, wherein said ultrasound sensor further includes a power supply connected to said pulse generator, said al least one transducer and said controller for energizing said pulse generator, said at least one transducer, and said controller.

17. A system as recited in claim 15, wherein said ultrasound sensor further includes an analog circuit coupled to both said at least one transducer and said controller for amplifying and filtering said echoes received from said at least one transducer.

18. A system as recited in claim 15, wherein said controller being further configured to drive said transducer via said pulse generator, to emit ultrasound wave pulses at a selected frequency, and to collect echoes at certain period of time.

19. A system as recited in claim 15, wherein said at least one transducer coupled to the ultrasound pulse signal generator for receiving said ultrasound pulse signal includes a first transducer for emitting the ultrasound beam in the container in response to said ultrasound pulse signal, and a second transducer for receiving the ultrasound echoes indicative of the changes of environment in the container in response to said ultrasound beam.

20. A system as recited in claim 1, further comprising Input/Output (I/O) means; said controller being further configured to generate an output signal indicative of the fluid level in the container and to output this signal to the I/O means.

21. A system as recited in claim 1, further comprising a memory coupled to said controller.

22. A system as recited in claim 21, wherein said memory includes a look-up table to be accessed by the controller for associating a fluid level to a volume of fluid in the container.

23. A system as recited in claim 22, wherein said container has different cross-sections along its height.

24. A system as recited in claim 21, wherein said memory is an EEPROM (Electrically Erasable Programmable Read Only Memory).

25. A system as recited in claim 1, wherein said ultrasound sensor is positioned within the container.

26. A system as recited in claim 1, wherein said ultrasound sensor is positioned outside the container, the container including an opening for allowing passage of the ultrasound beam in the container.

27. A system as recited in claim 1, wherein said ultrasound sensor is positioned adjacent the top of the container and being oriented so as to emit an ultrasound beam along an ultrasound beam path generally oriented towards the bottom of the container.

28. A system as recited in claim 1, wherein said ultrasound sensor is positioned adjacent the bottom of the container and being oriented so as to emit an ultrasound beam along an ultrasound beam path generally oriented towards the top of the container.

29. A system as recited in claim 1, wherein the container is a gas tank and the system is a gas level gauge.

30. A system as recited in claim 29, wherein said gas tank is a vehicle's gas tank and said ultrasound sensor is triggered by computer from said car.

31. A method for measuring fluid level in a container, the method comprising:
i) emitting an ultrasound beam from a source along an ultrasound beam path intersecting a fluid interface in the container;
ii) receiving ultrasound echo values in indicative of changes of environment along said ultrasound bean path; and
iii) determining a fluid level in said container by associating at least one of said echo values to the fluid interface.

32. A method as recited in claim 31, wherein step iii) including using at least some of said echo values to determine respective distances from said source of said changes of environment along said ultrasound beam path.

33. A method as recited in claim 32, wherein step iii) further including: comparing said at least one of said echo values associated to the fluid interface to a predetermined position of said fixed target along said ultrasound beam path to determine said fluid level.

34. A method as recited in claim 31, wherein said ultrasound beam path has at least one section non perpendicular to the fluid interface; using said echo values to determine distance from said source of said changes of environment along said ultrasound beam path includes considering a length of said at least one section of said ultrasound beam path non perpendicular to the fluid interface.

35. A method as recited in claim 31, wherein using said echo values to determine distance from said source of said changes of environment along said ultrasound beam path includes further using at least one of a geometry of the container and at least one property of the fluid.

36. A method as recited in claim 31, wherein said fluid level is determined repetitively by repeating steps i) to iii).

37. A method as recited in claim 36, wherein in iii) said at least some of said echo values being selected from a measurement window along said ultrasound beam path, said measurement window is characterized by upper and lower limit positions along said ultrasound beam path; said measurement window including said a prior fluid interface position as predetermined prior to step i).

38. A method as recited in claim 37, wherein said prior fluid interface position is predetermined during an initialisation step.

39. A method as recited in claim 37, wherein said upper and lower limit positions being positioned at different distance from said prior fluid interface as predetermined prior to step i).

40. A method as recited in claim 37, wherein said upper and lower limit positions are determined relatively to said prior fluid interface position using a rate of change of fluid level.

41. A method as recite din claim 36, wherein said fluid level is determined repetitively by repeating steps i) to iii) at a predetermined scanning frequency.

42. A method as recited in claim 31, wherein said ultrasound beam path is defined by a conduit.

43. A method as recited in claim 31, further comprising associating the fluid level to a volume of fluid in the container.

44. A method as recited in claim 31, wherein in ii) echo values e(i) indicative of changes of environment along said ultrasound beam path are considered for a number l of sensing positions i along said ultrasound beam path; comparing each said echo value e(i) being compared ) to a detection threshold dt(i) corresponding to said sensing position (i); whereby, a change of environment is detected along said ultrasound beam path when said echo value e(i) is greater than said detection threshold dt(i).

45. A method as recited in claim 31, wherein using said echo values to determine distance from said source of said changes of environment along said ultrasound beam path Includes determining a tilt of the container and using said tilt to determine said distance from said source of said environment changes.

46. A method as recited in claim 45, wherein said determining a tilt of the container includes identifying a transition window along said ultrasound beam path and determining the height of said transition window; said transition window being identifiable by echoes indicative of two fluids.
